(19) United States
(12) Patent Application Publication
(10) Pub. No.: US 2010/0276010 A1
(43) Pub. Date: Nov. 4, 2010

(54) ATTACHMENT FOR USE IN FLEXIBLE EXTENSION DEVICE FOR FAUCET STEM

(76) Inventor: Donald W. Jacobsmeyer, St. Louis, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/772,780

(22) Filed: May 3, 2010

Related U.S. Application Data
(60) Provisional application No. 61/174,701, filed on May 1, 2009.

(51) Int. Cl. F16K 13/00

(52) U.S. Cl. 137/315.01

(57) ABSTRACT

An attachment (A) for use with a flexible extension device (10) for a faucet (F). The device has an elongate flexible section (12), a coupling (14) which connects to the attachment for turning a faucet handle (H), and a second end of which is connected to a handle (18) operable by a user to remotely turn the faucet handle and open or close the faucet. The attachment includes a first plate (22) installed under the faucet handle about a valve stem (S) to which the faucet handle is attached. A second plate (24) fits over the faucet handle and has a boss (32) formed on an outer surface (34) thereof for engagement with the coupling to connect the attachment to the flexible extension. A plurality of fasteners (40) attaches the plates together with the faucet handle sandwiched between them. With the attachment installed, rotation of the flexible extension by the user causes the attachment to rotate in an appropriate direction; and, rotation of the attachment turns the faucet handle, also in the appropriate direction, to open and close the faucet.

### CROSS-REFERENCE TO RELATED APPLICATIONS

U.S. Provisional Patent Application Ser. No. 61/174,701 filed May 1, 2009.

### STATEMENT REGARDING FEDERALLY SPONSORED RESEARCH

Not Applicable.

### BACKGROUND OF THE INVENTION

This invention relates to a flexible extension device attachable to the faucet stem of a valve used in the home or in industrial applications for remotely turning the facet to open and close the valve; and, more particularly, to an attachment by which a flexible extension device is connected to the faucet to facilitate its turning.

As noted in non-provisional patent application Ser. No. 12/323,012, it is not uncommon for a faucet such as an outdoor faucet to which a hose is attached for watering the yard, etc., or for a faucet located in a basement or a utility room near laundry equipment to be inaccessible so that it is difficult for user to operate it and turn it on and off. This can particularly be a problem for handicapped people, people with limited mobility, people with arthritis or other medical conditions to either reach the faucet handle or if it can be reached, operate it.

It is also the situations in numerous commercial or industrial settings for a faucet to be in an out-of-the-way place so an employee has difficulty reaching and operating it. Thus, while in some circumstances it may be simpler to relocate the faucet for easier access, oftentimes this is not practical or is too expensive.

In the referenced provisional patent application, there is described a flexible extension device for operating a faucet. In practicing the invention, the faucet's handle may be removed for one end of a flexible section of the device to be coupled to the faucet's stem, with a handle then being attached to the other end of the section for turning it. The handle is readily accessible to the faucet's user for remote operation of the faucet.

The present invention is directed to a mechanism by which the one end of the flexible section of the device is connected or attached to the faucet handle.

### BRIEF SUMMARY OF THE INVENTION

The present disclosure is directed to an attachment for coupling a flexible extension device to a faucet or faucet handle for the device to remotely turn the faucet on and off.

In one embodiment, the attachment comprises a pair of plates a first one of which is installed beneath the faucet handle about the valve stem to which the handle is attached. The second plate fits over or above the faucet handle. The plates have corresponding holes or slots through which fasteners extend to connect the plates together. The second plate includes a boss for engaging one end of the flexible extension of the device to the plate. Rotation of the extension by the user now causes the attachment to rotate in the appropriate direction, rotation of the attachment turning the faucet handle in the appropriate direction to open and close the faucet.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1A is an exploded view of a flexible extension device installed on a faucet using an attachment of the present invention to make the faucet operable for one unable to otherwise operate it, and FIG. 1B is an exploded view of how a flexible shaft of the device connects to an attachment used with the faucet;

FIG. 2A is plan view of a first plate of a first embodiment of the attachment, and FIG. 2B is an elevation view thereof;

FIGS. 3A and 3B are respective top and bottom plan views of a second plate of the first embodiment of the attachment, and FIG. 3C is an elevation view thereof;

FIG. 4 illustrates installation of the attachment about a faucet handle and connection of the attachment to a coupling of the flexible extension device;

FIG. 5A is plan view of a first plate of a second embodiment of the attachment, and FIG. 5B is an elevation view thereof;

FIGS. 6A and 6B are respective top and bottom plan views of a second plate of the second embodiment of the attachment, and FIG. 6C is an elevation view thereof;

FIGS. 7A-7C are respective top and bottom plan views and an elevation view of a third second embodiment of the attachment;

FIG. 8 is an elevation view of the third embodiment installed about a faucet handle;

FIG. 9 is an elevation view of the attachment with C clamps used to fasten the attachment about the faucet handle;

FIGS. 10A and 10B are sectional views of a coupling illustrating an attachment for connection of the device to a threaded faucet stem;

FIG. 11A illustrates a fluted faucet stem, and FIGS. 11B and 11C illustrate a coupling for connection of the device to the fluted faucet stem, FIG. 11B being a sectional view of the coupling and FIG. 11C a plan view thereof;

FIG. 12 is a sectional view of another form of attachment employing a coupling fitted onto a faucet stem and attached to a collar on the one end of the extension shaft of the device;

FIGS. 13A and 13B are respective sectional plan views and elevation views of another embodiment of the attachment; and,

FIG. 14 is an elevation view of yet another embodiment of the attachment.

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a flexible extension device 10, such as described in non-provisional patent application Ser. No. 12/323,012, includes a flexible shaft 12 which is, for example, 2′, 4′, 6′, or greater in length. One end of shaft 12 attaches to an attachment 20 by which device 10 connects to the faucet to remotely operate the faucet. For this purpose, shaft 12 is threaded at each end and a post 14 of attachment 20 has a threaded bore 15 into which this one end of the shaft is screwed to secure the shaft to the attachment. As described hereinafter, attachment 20 connects to either handle H of the faucet or to a valve stem S of the faucet. As is known in the art, handle H is connected to the outer end of stem S for turning of the handle to open and close the faucet.

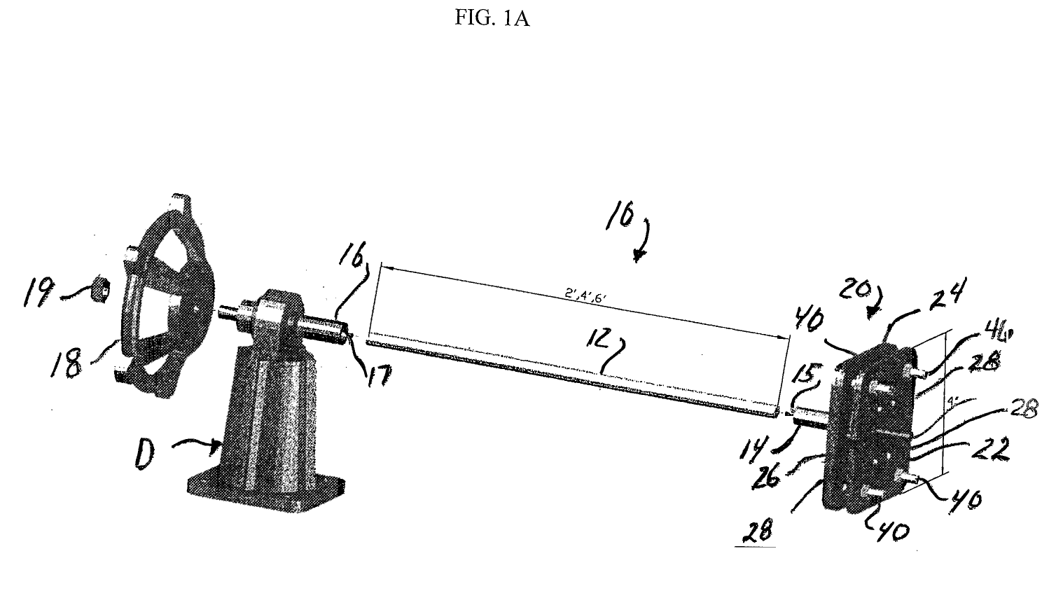

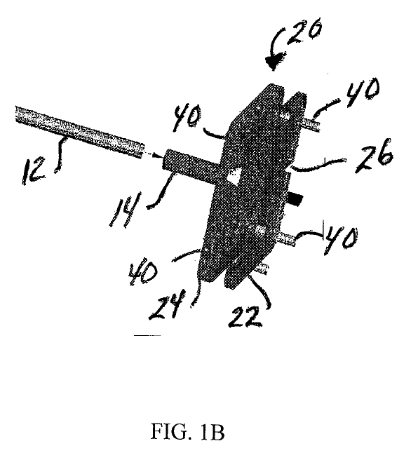

The other end of shaft 12 is attached to one end of a rotatable rod 16. As shown in FIG. 1, this end of the rod has a threaded bore 17 and the end of shaft 12 is screwed into this bore to attach it to the rod. A handle 18 attaches to the other, threaded end of rod 16, and is secured in place using a nut 19 that threads onto the rod. Rod 16 is rotatably mounted on a stand D. The stand is installed at an appropriate location that allows the user to easily and conveniently access and turn handle 18 and operate the faucet. This turning motion is conveyed by shaft 12 to handle H or stem S of the faucet to turn the faucet “on” and “off”. Those skilled in the art will appreciate that the ends of shaft 12 can be connected to attachment 20 and rod 16 in a variety of other ways without departing from the scope of the invention.

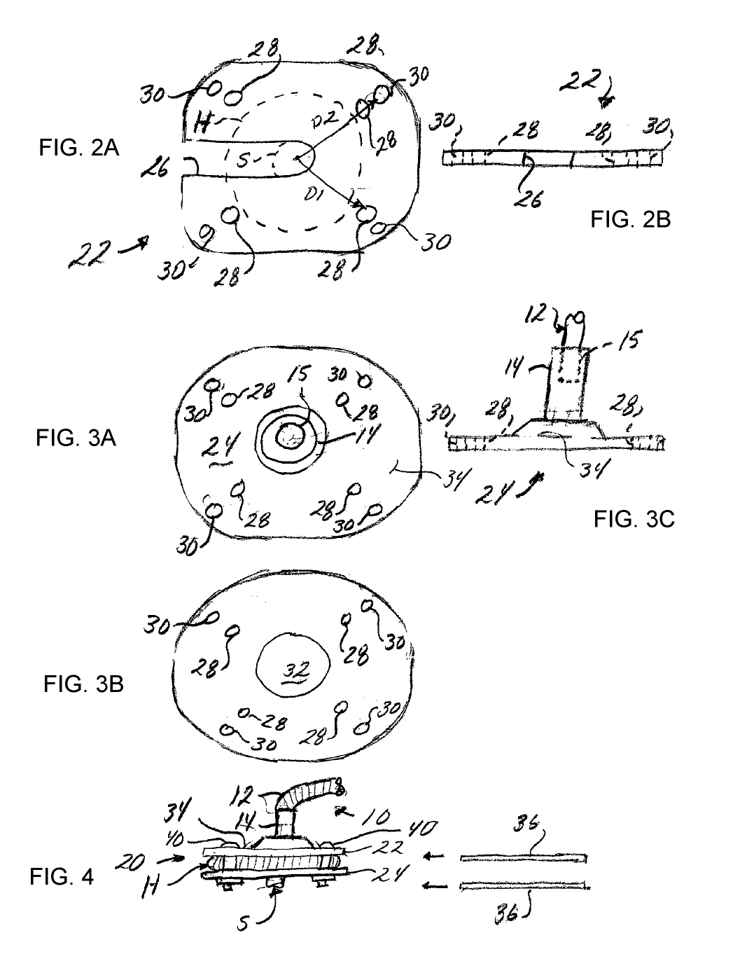

Referring to FIGS. 2A and 2B, and FIGS. 3A-3C, attachment 20 comprises a pair of plates 22, 24 which can generally rectangular (square) in shape as shown in FIGS. 1A and 1B, round as shown in FIGS. 2A, 3A and 3B, or of another geometric shape without departing from the scope of the invention. Plate 22 fits on the underside of handle H, and plate 24 fits over the top of the handle.

As shown in FIGS. 2A and 2B, plate 22, a slot 26 extends inwardly into the body of the plate from one edge thereof, the length and width of the slot being sufficient for plate 22 to be fitted about stem S of the faucet. The inner end of the slot is rounded so to fit the rounded contour of the stem. A first set of holes 28 are spaced about the plate. The holes are 90° apart and each hole is located a distance D1 from the center of the plate. A second set of holes 30 are also spaced about the plate. These holes are also 90° apart and each hole is located a distance D2 from the center of the plate, this distance being greater than the distance D1. The respective sets of holes allow attachment 20 to be used with faucets having handles of different sizes so the attachment can be used in a variety of installations.

Referring to FIGS. 3A-3C, plate 24, for convenience, corresponds in size and shape to plate 22. As with plate 22, a first set of holes 28 are spaced about plate 24. Again, the holes are 90° 2 apart and each hole is located a distance D1 from the center of the plate. A second set of holes 30 are also spaced about plate 24. These holes are again 90° apart and each hole is located a distance D2 from the center of the plate, this distance being greater than the distance D1. As noted, the respective sets of holes allow attachment 20 to be used with faucets having handles of different sizes so the attachment can be used in a variety of installations. As shown in FIGS. 3A and 3C, post 14 is formed on an upper surface 34 of plate 24, the boss being centrally formed on this surface of the plate. The post projects outwardly from the plate and as previously indicated has a threaded bore 15 extending inwardly into the post from its outer end for engagement with the one end of shaft 12.

Referring to FIG. 4, assembly of attachment 20 to the faucet handle is shown. When plates 22 and 24 of the attachment are assembled in place, they are connected together using fasteners 40 which are, for example, nuts and bolts. Faucet handle H is now captured between the plates and sandwiched between them. Also shown in FIG. 4 are a pair of pads 36. This pads, which are of an elastomeric material, are respectively placed between the underside of pad 22 and the upper face of handle H and the topside of plate 24 and the underside of the handle. Those skilled in the art will understand that the pads can be permanently attached to these respective plate surfaces. The pads help grip the plates with the handle so to prevent slippage of the handle when it is being turned.

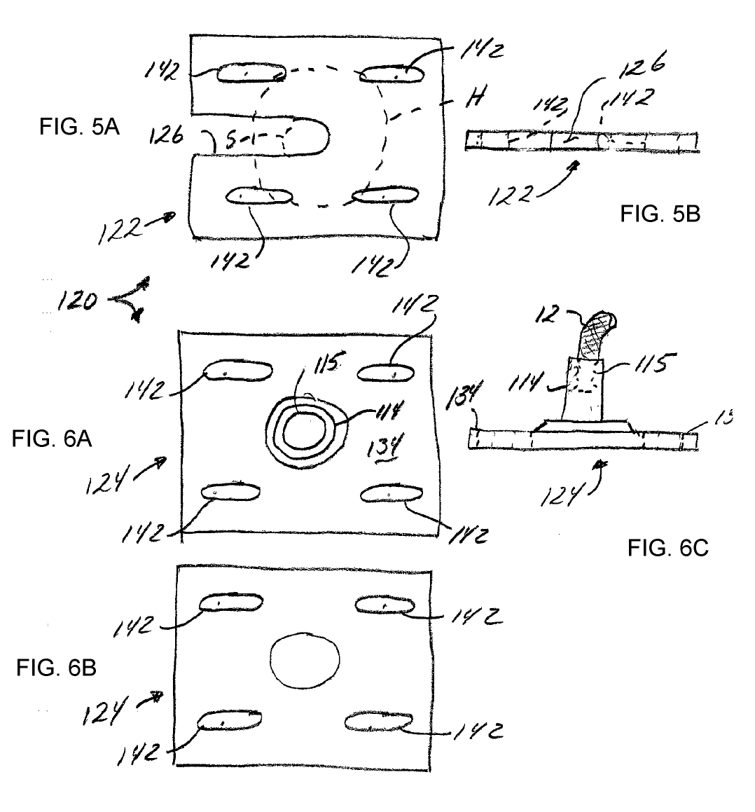

Referring now to FIGS. 5A-6C, a second embodiment of the invention comprises an attachment 120 comprising plates 122 and 124. As shown in FIGS. 5A and 5B, plate 122 comprises a generally rectangular metal plate with a slot 126 extending inwardly into the body of the plate with the length and width of the slot sized for the plate to fit about stem S of the faucet. Again, the inner end of the slot is rounded so to fit the rounded contour of the stem. Now, instead of holes, or sets of holes formed in the plate, a first set of slots 142 are spaced about the plate. The slots substantially identical in size and shape and are located 90° apart from each other. The slots allow attachment 20 to be used with faucets having handles of different sizes; again, so the attachment can be used in a variety of installations.

As shown in FIGS. 6B and 6C, plate 24 is also generally rectangular metal plate. For convenience, plate 24 corresponds in size to plate 22. Plate 24 also has a set of the slots 142 corresponding to those formed in plate 122. Those skilled in the art will understand that while the slots 142 shown in both plates 122 and 124 straight slots, the slots could be curved or arcuate slots. As shown in FIGS. 5A and 5C, a post 114 is formed on an upper surface 134 of plate 124, the post again being centrally formed on this surface of the plate. A threaded bore 115 extends inwardly from the outer end of the post for connection of shaft 12 to attachment 120.

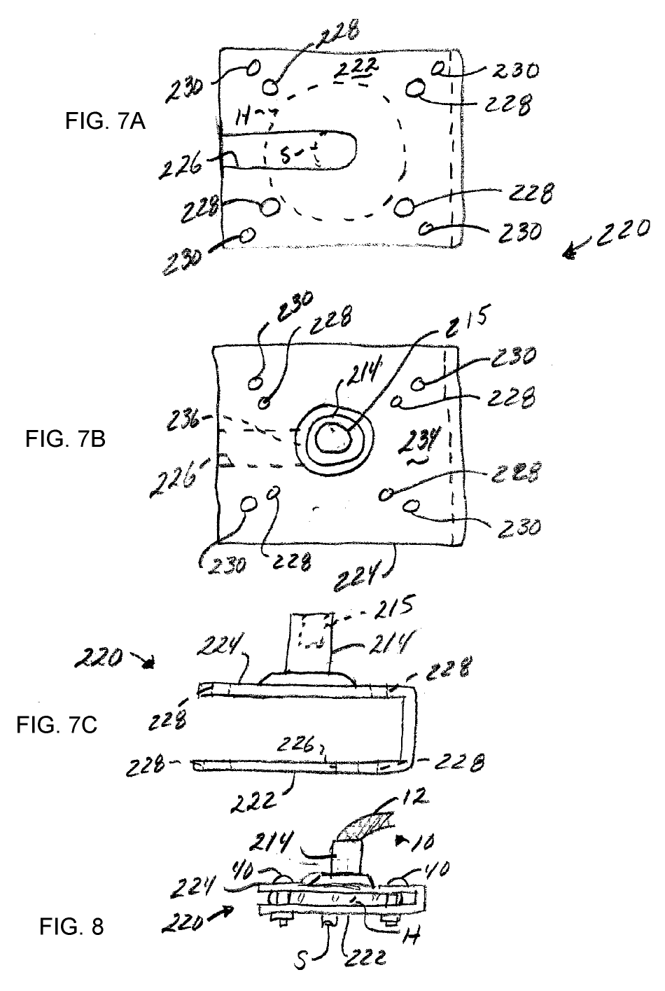

In FIGS. 7A-7C, and 8, a third embodiment of the invention comprises an attachment 220. This attachment, rather than including separate plates, is a generally U-shaped attachment having an upper plate 222 and a lower plate 224. As seen in FIGS. 7A and 7B, both plates 222 and 224 are generally rectangular metal plates. Plate includes a slot 226 extending inwardly into the body of the plate. Again, the length and width of the slot is sized for plate 222 to fit about stem S of the faucet when attachment 220 is fitted into place. As with the other embodiments, the inner end of this slot is rounded so to fit the rounded contour of the stem. As shown in FIGS. 7B and 7C, a post 214 is formed on an upper surface 234 of plate 224, the boss being centrally formed on this surface of the plate. A threaded bore 215 extends inwardly into the post for connection of shaft 12 to post 214.

As with the plate 22 and 24, a first set of holes 228 are spaced about the plates 222 and 224. The holes are 90° apart and each hole is located a first distance from the center of the plate. A second set of holes 230 are also spaced about plates 222 and 224. These holes are again 90° apart and each hole is located a second distance from the center of the plate. The respective sets of holes allow attachment 220 to be used with faucets having handles of different sizes so the attachment can be used in a variety of installations.

Installation of attachment 220 about faucet F is shown in FIG. 8. The attachment is fitted about handle H of the faucet so plate 222 slides beneath the handle with stem S being received in slot 226 of the plate, and with plate 224 sliding over the top of the handle. Once the attachment is in place, fasteners 40 are installed in the appropriate holes 228 or 230 to compress handle H between the plates. Shaft 12 is then coupled to the attachment for rotation of the flexible extension to rotate handle H in the desired direction to open and close the faucet.

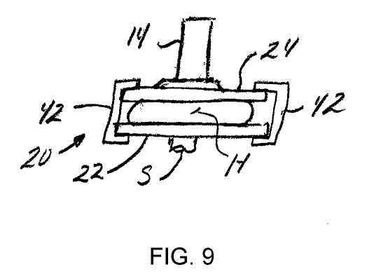

Besides the fasteners 40 used to secure the attachment about faucet handle H, those skilled in the art will appreciate that other means of fastening can be used without departing from the scope of the invention. Thus, as shown in FIG. 9, plates 22 and 24 of attachment 20 are secured about faucet handle H using C clamps 42. The clamps are made of a spring steel or similar material so to compress the plates together when fitted about the handle. Also, while two C clamps are shown in FIG. 9, more than two clamps can be used to clamp plates 22 and 24 together. However, if attachment 220 is used, only one C clamp may be required to secure the attachment about the handle.

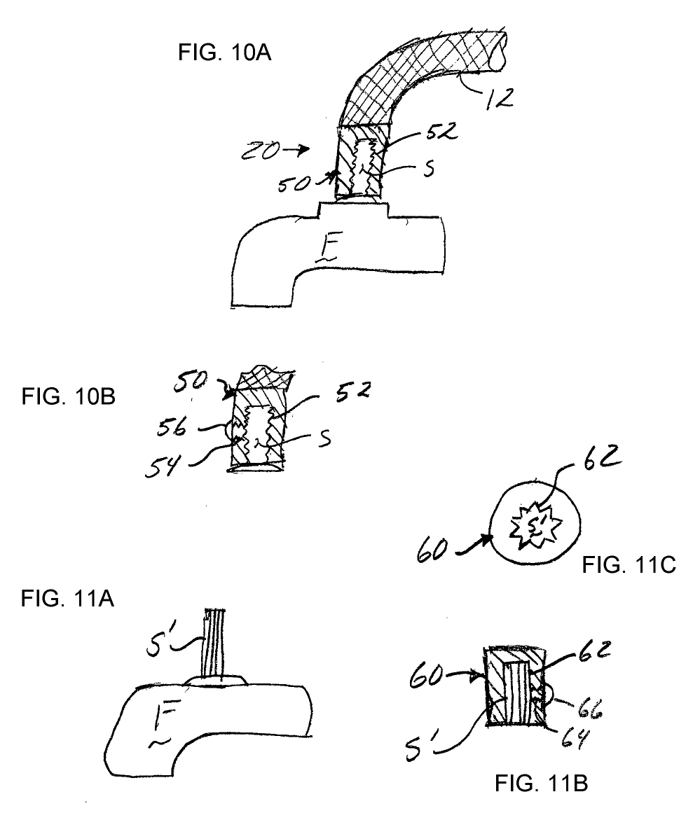

It will be understood by those skilled in the art that besides use of attachment 20 by which device 10 is connected handle H of a faucet, device 10 can also be connected to the stem of the faucet to which the handle is ordinarily connected in order to operate the faucet's valve. In these applications, the handle is first removed. Then, as shown in FIG. 10, attachment 20 now includes a coupling 50 which has an internally threaded bore 52. Coupling 50 is threaded onto stem S to attach connector 20 to the faucet. Rotation of shaft 12 then rotates the stem in the appropriate direction to open and close the faucet. As shown in FIG. 11, coupling 50 may also include a transversely threaded bore 54 for a set screw 56.

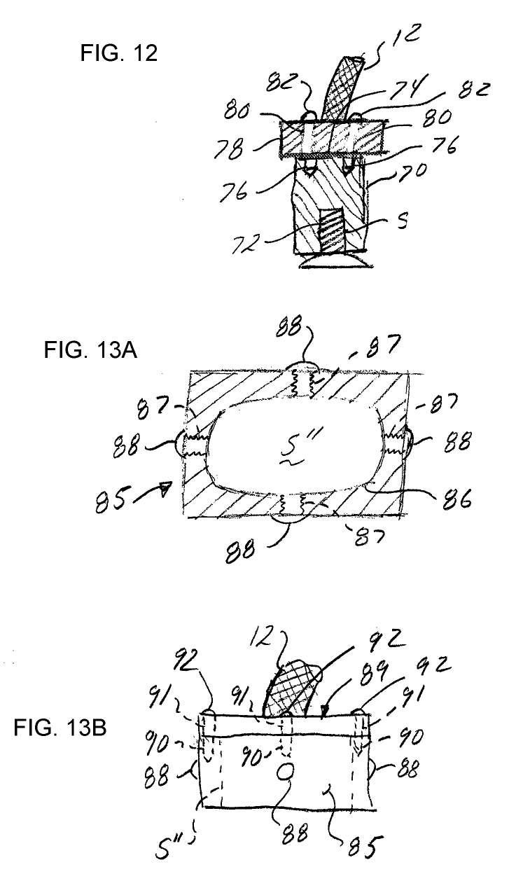

Not all faucet stems are threaded. As shown in FIG. 12A, some faucet stems S′ are fluted. In these situations, attachment 20 includes a coupling 60. As shown in FIGS. 12B and 12C, coupling 60 has a central, fluted bore 62 which allows the coupling to be fitted onto stem S′. Again, the coupling 50 may also include a transversely threaded bore 64 for a set screw 66. Because device 10 is reusable and may be connected to a to a threaded stem one time, and a fluted stem another time, couplings 50 and 60 are interchangeable.

In an embodiment of the invention shown in FIG. 12, a coupling 70 has a threaded bore 72 that allows the coupling to be threaded onto stem S. A pair of threaded holes 74 is formed in upper face 76 of the coupling. Now, shaft 12 has a collar 78 fitted on its one end, the collar having spaced bores 80 corresponding to the holes 74 for screws 82 to be inserted through the collar and threaded into the holes 74 to attach the collar to the coupling. Those skilled in the art will understand that while a threaded stem is shown in FIG. 12, a coupling fitting onto a fluted stem can also be used.

Besides the types of faucets or valves found in or about a house, device 10 is also for use with large, industrial type valves or faucets. In many commercial or industrial facilities, as well as on boats and other vehicles, these are often located in out-of-the-way, hard to reach places. In such settings, the ability to remotely (and precisely) open and close a faucet or valve simplifies many operations; and, in some instances, enhances the safety of operating personnel.

Referring to FIGS. 13A and 13B, a valve stem S″ is for an industrial valve or faucet. This type of valve stem is generally rectangular or square with each side of the stem being slightly rounded. In the embodiment of FIGS. 13A and 13B, an attachment 84 is for connecting shaft 12 to the stem S″. A cover 85 has a central opening 86 which generally conforms in size and shape to the stem allowing the collar to be fitted about the stem. A threaded bore 87 extends is centrally located on each side of the stem for a bolt 88 to inserted into the bore until the inner end of the bolt bears against a side of stem S″.

As shown in FIG. 13, the one end of shaft 12 has a collar 89 which can have the same length and width dimensions as cover 85; or, although not shown, could be of a circular or oval shape. The collar has four holes 91 extending through it, these holes being spaced 90° apart. Corresponding threaded holes 90 extend down into cover 85 from the top of the collar. These holes 90, 91 allow screws 92 to be inserted through collar 89 into cover 85 to affix the one end of shaft 12 to the cover so when shaft 12 is rotated, attachment 84 turns stem S″ in the appropriate direction.

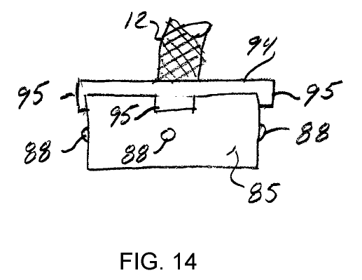

Another type of attachment that can be used in this application is shown in FIG. 14. In this embodiment, cover 85 is made of a magnetic material. Collar 94 which is attached to the one end of shaft 12 and fits over the top of cover 85 is also of a magnetic material. In addition, collar 94 has ears 95 which extend over each side of cover 85 to help keep collar 94 in place and assist in turning stem S″ when shaft 12 is rotated.

In view of the above, it will be seen that the several objects and advantages of the present disclosure have been achieved and other advantageous results have been obtained.

Having thus described the invention, what is claimed and desired to be secured by Letters Patent is:

1. An attachment for use with a flexible extension device for a faucet, the device having an elongate flexible section a first end of which is connected to a faucet handle for turning the faucet handle, and a second end of which is coupled to a handle operable by a user to remotely turn the faucet handle and open or close the faucet, the attachment including:
a first plate installed beneath the faucet handle about the valve stem to which the faucet handle is attached;
a second plate which fits over the faucet handle, said second plate having a boss formed on an outer surface for engagement with said first end of the flexible extension to connect the attachment to the flexible extension; and,
fastening means for attaching the plates together with the faucet handle sandwiched therebetween whereby rotation of the flexible extension by the user causes the attachment to rotate in an appropriate direction, rotation of the attachment turning the faucet handle also in the appropriate direction to open and close the faucet.

2. The attachment of claim 1 is which the first plate has a slot formed therein for installing the plate about the stem of the faucet.

3. The attachment of claim 2 in which the first and second plates have a plurality of correspondingly placed holes formed therein for insertion of the fastening means through the holes so to attach the plates together about the faucet handle.

4. The attachment of claim 2 in which the first and second plates have a plurality of correspondingly shaped slots formed therein for insertion of the fastening means through the slots so to attach the plates together about the faucet handle.

5. The attachment of claim 3 in which the holes are uniformly located about the respective plates so to be in registry with each other when the plates are in place.

6. The attachment of claim 4 in which the slots are uniformly located about the respective plates so to be in registry with each other when the plates are in place.

7. The attachment of claim 1 in which the fasteners allow the plates to snap fit together.

8. The attachment of claim 1 wherein the length and width of the plates is equal to or greater than a diameter of the faucet handle to facilitate attaching the plates about the faucet handle.

9. The attachment of claim 1 which is a U-shaped attachment the respective first and second plates of which fit about the faucet handle.

10. The attachment of claim 1 in which the fastening means includes at least one C clamp.

11. An attachment for use with a flexible extension device for a valve, the device having an elongate flexible section a first end of which is connected to a valve stem for turning the valve open and closed, and a second end of which is coupled to a handle operable by a user to remotely turn the valve open or closed, the attachment including a coupling attached to said first end of the section, the coupling fitting over the stem to connect the coupling and the stem, the coupling being rotatable with said flexible section for rotation of said flexible section in the appropriate direction to open and close the valve.

12. The attachment of claim 11 in which the stem is a threaded stem and the coupling has a threaded bore for threadingly receiving the stem to attach the coupling and the stem.

13. The attachment of claim 11 in which the stem is a fluted stem and the coupling has a fluted bore with which the stem interfits to attach the coupling and the stem.

14. The attachment of claim 11 in which the coupling further includes a threaded transverse bore for insertion of a set screw used to keep the stem in place.

15. The attachment of claim 11 further including a collar to which said first end of the section is attached, the collar being connected to the coupling for rotation of said flexible section in the appropriate direction to open and close the valve.

16. An attachment for use with a flexible extension device for a valve, the device having an elongate flexible section a first end of which is connected to a valve stem for turning the valve open and closed, and a second end of which is coupled to a handle operable by a user to remotely turn the valve open or closed, the attachment including a cover fitting about the valve stem and a coupling attached to said first end of the section, the coupling being connected to the cover, and the coupling being rotatable with said flexible section for rotation of said flexible section in the appropriate direction to cause rotation of the cover and open and close the valve.

17. The attachment of claim 16 in which the cover has at least one threaded transverse bore for insertion of a set screw used to attach the cover to the stem.

18. The attachment of claim 16 in which the cover has a plurality of threaded transverse bores spaced about the cover for insertion of set screws used to attach the cover to the stem.

19. The attachment of claim 16 further including a collar to which said first end of the section is attached, the collar being connected to the cover for rotation of said flexible section in the appropriate direction to open and close the valve.

20. The attachment of claim 19 in which the cover and the collar are each of a magnetic material for a magnetic force to hold the cover and collar together.

21. The attachment of claim 20 in which the collar has ears which extend over the side of the cover to help keep the collar in place and assist in turning the stem when the flexible section is rotated
